(19) United States
(12) Patent Application Publication
(10) Pub. No.: US 2004/0221734 A1
(43) Pub. Date: Nov. 11, 2004

(54) Bread maker and control method thereof

(75) Inventors: Jae-ryong Park, Suwon-city (KR); Yong-hyun Kwon, Suwon-city (KR); Chul Kim, Anyang-city (KR); Tae-uk Lee, Suwon-city (KR); Han-jun Sung, Suwon-city (KR); Jang-woo Lee, Suwon-city (KR); Dong-bin Lim, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/805,312

(22) Filed: Mar. 22, 2004

(30) Foreign Application Priority Data
May 7, 2003 (KR) 2003-28978

(51) Int. Cl. A23L 1/00

(52) U.S. Cl. 99/348

(57) ABSTRACT

A bread maker according to the present invention including: a main body forming an oven compartment; upper and lower kneading drums spaced apart from each other inside the oven compartment, each kneading drum having a holder holding opposite ends of a mixing bag filled with raw materials; a drum driving part rotating the upper and lower kneading drums; a rotation sensing part sensing rotation positions of the holder of the upper kneading drums; and a controller which controls the drum driving part so that when an initial power is supplied, the upper kneading drum is rotated by a predetermined angle to make the holder of the upper kneading drum stop within a predetermined angle range in which the holder of the upper kneading drum faces frontward on the basis of a position sensing signal of the rotation sensing part. Thus, in a predetermined process, holders provided in kneading drums stop within a predetermined angle range in which the holders thereof face frontward, so that the mixing bag can be easily attached to the holders.

### CROSS-REFERENCE TO RELATED APPLICATIONS

This application claims the benefit of Korean Application No. 2003-28978, filed May 7, 2003, in the Korean Intellectual Property Office, the disclosure of which is incorporated herein by reference.

### BACKGROUND OF THE INVENTION

1. Field of the Invention

The present invention relates to a bread maker and a control method thereof, and more particularly to a bread maker and a control method thereof, wherein in a predetermined process, holders provided in kneading drums of the bread maker and holding opposite ends of a mixing bag filled with raw materials to make bread stop within a predetermined angle range in which the holders thereof face frontward.

2. Description of the Related Art

Generally, a bread maker kneads raw materials for bread by rotation of kneading drums after a mixing bag filled with raw materials is wound on the kneading drums. Thus, it is required for a user to attach the mixing bag on holders of the kneading drums.

Herein, the user has adjusted a rotation angle of the kneading drums so that the holders of the kneading drums can face frontward.

### SUMMARY OF THE INVENTION

It is an aspect of the present invention to provide a bread maker and a control method thereof, wherein in a predetermined process, holders provided in kneading drums of the bread maker and holding opposite ends of a mixing bag filled with raw materials for bread stop within a predetermined angle range in which the holders thereof face frontward.

Therefore, a bread maker according to the present invention, comprises: a main body forming an oven compartment; upper and lower kneading drums spaced apart from each other inside the oven compartment, each kneading drum having a holder holding opposite ends of a mixing bag filled with raw materials; a drum driving part rotating the upper and lower kneading drums; a rotation sensing part sensing rotation positions of the holder of the upper kneading drums; and a controller which controls the drum driving part. Thus, when an initial power is supplied, the upper kneading drum is rotated by a predetermined angle to make the holder of the upper kneading drum stop within a predetermined angle range in which the holder of the upper kneading drum faces frontward on the basis of a position sensing signal of the rotation sensing part.

In an aspect of the invention, the controller controls the drum driving part so that an upper end of the mixing bag is wound on the upper kneading drum by a predetermined length after being attached to the holder of the upper kneading drum, and then the holder of the lower kneading drum stops within a predetermined angle range in which the holder of the lower kneading drum faces frontward.

In an aspect of the invention, the controller controls the drum driving part so that after a kneading process is completed, the mixing bag is downwardly wound to be detached from the upper kneading drum and wound on the lower kneading drum, and then the lower kneading drum is rotated to unwind the mixing bag until the holder of the lower kneading drum stops within a predetermined angle range in which the holder of the lower kneading drum faces frontward.

In an aspect of the invention, the holder comprises a plurality of holding projections and the mixing bag has holding holes engaged to the holding projections.

Therefore, a method of controlling a bread maker having a main body forming an oven compartment, upper and lower kneading drums spaced apart from each other inside the oven compartment with each kneading drum having a holder holding opposite ends of a mixing bag filled with raw materials, and a drum driving part rotating the kneading drums to knead the raw materials contained in the mixing bag, according to the present invention, comprises supplying an initial power; rotating the upper kneading drum by a predetermined angle; sensing positions of the holder of the upper kneading drum; and making the holder of the upper kneading drum stop within a predetermined angle range in which the holder of the upper kneading drum faces frontward.

In an aspect of the invention, the method further comprises attaching an upper end of the mixing bag to the upper kneading drum and winding the upper end of the mixing bag onto the upper kneading drum by a predetermined length; making the holder of the lower kneading drum stop within a predetermined angle range in which the holder of the lower kneading drum faces frontward; and attaching a lower end of the mixing bag to the holder of the lower kneading drum.

In an aspect of the invention, the method further comprises kneading the raw materials in the mixing bag by rotating the upper and lower kneading drums clockwise and counterclockwise; downwardly winding the mixing bag after the kneading process is completed; detaching the upper end of the mixing bag from the upper kneading drum; winding the mixing bag on the lower kneading drum; rotating the lower kneading drum so that the wound mixing bag can be unwound from the lower kneading drum; and making the holder of the lower kneading drum stop within a predetermined angle range in which the holder of the lower kneading drum faces frontward.

Additional and/or other aspects and advantages of the invention will be set forth in part in the description that follows, and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompany drawings of which:

FIG. 1 is a perspective view of a mixing bag filled with raw materials and a bread maker according to an embodiment of the present invention;

FIG. 2 is a cut-away perspective view of a component compartment of the bread maker in FIG. 1;

FIG. 3 is an enlarged exploded view of a rotation sensing part of the component compartment in FIG. 2;

FIG. 4 is a control block diagram of the bread maker in FIG. 1; and

FIG. 5 is a control flow diagram of the bread maker in FIG. 1.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

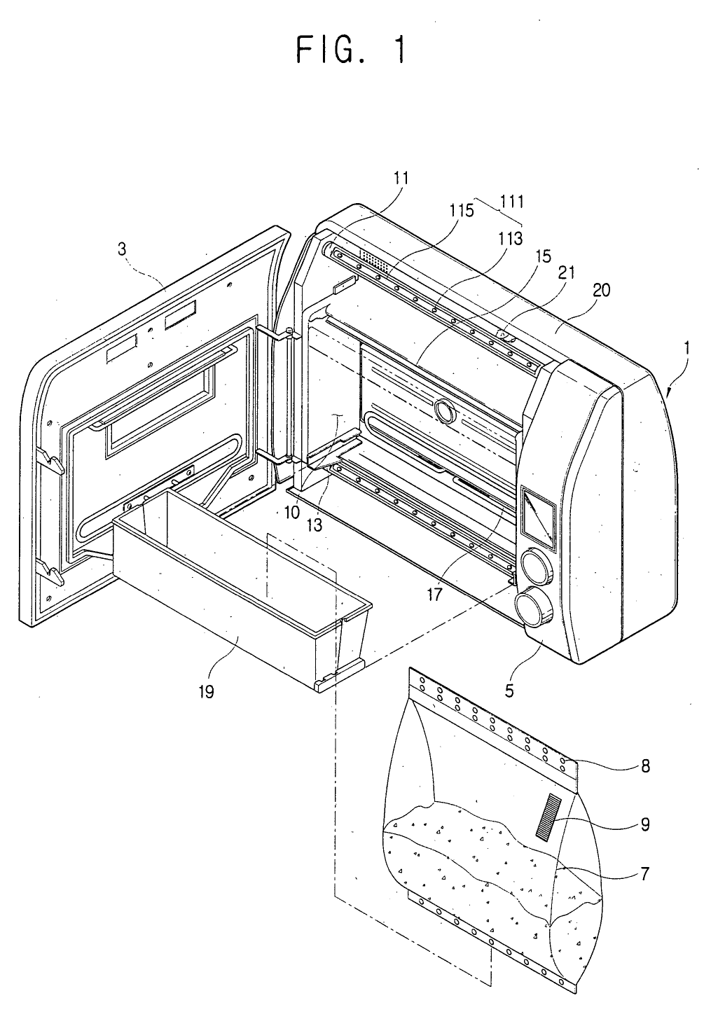

As shown in FIG. 1, a bread maker according to an embodiment of the present invention includes a main body 1 divided into an oven compartment 10 and an electric component compartment 20, a door 3 in the front of the main body 1 to open and close a front opening of the oven compartment 10, and a control panel 5 provided in the front of the main body 1 and displaying the status of the bread maker.

The oven compartment 10 includes upper and lower kneading drums 11 and 13 which are spaced from each other and provided in parallel, a baking tray 19 provided between the upper and lower kneading drums 11 and 13 and accommodating raw materials (ingredients) kneaded in the mixing bag 7, kneading members 15 provided in an upper part of the oven compartment 10 between the heaters 17 and the upper kneading drum 11 and preventing the raw materials in the mixing bag 7 from being slipped out of an upper part the baking tray 19, and heaters 17 respectively provided in a rear-side wall of the oven compartment 10, and upper and lower parts of the rear (a side toward the oven compartment 10) of the door 3 and heating an interior of the oven compartment 10.

The upper and lower kneading drums 11 and 13 comprise holders 111 provided along axes thereof and holding opposite ends of the mixing bag 7 filled with the raw materials. Also, upper and lower kneading drums 11 and 13 rotate clockwise and counterclockwise to knead the raw materials in the mixing bag 7. The holders 111 have holding planes 115 and holding projections 113 projected at regular intervals along the holding plane 115. However, the present invention is not limited to the above configuration. Holding grooves or holding clips may be substituted for the holding projection 113.

The electric component compartment 20 is provided in a rear part and one side of the oven compartment 10.

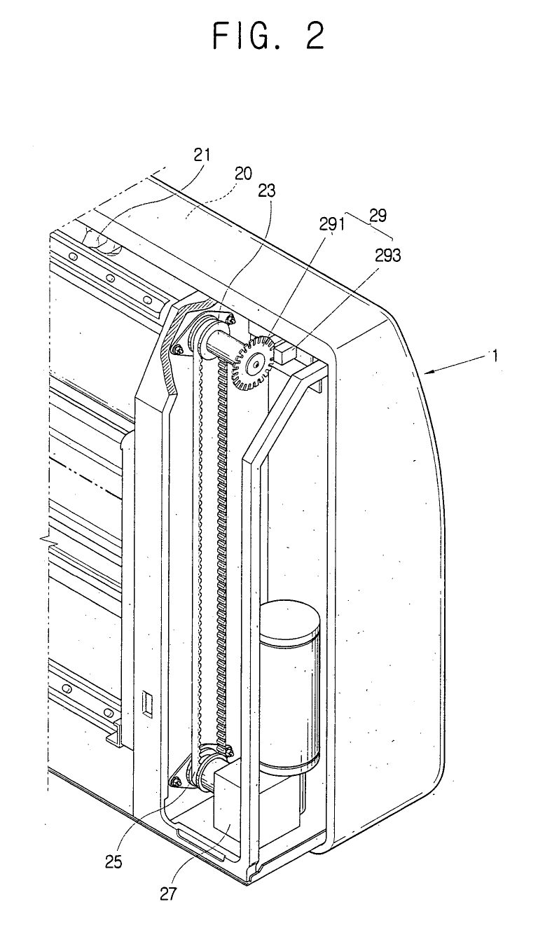

As shown in FIG. 2, one side of the oven compartment 10 includes a rotation sensing part 29, sensing a rotation position of at least one of the upper and lower kneading drums 11 and 13, rotation shafts 23 of the upper and lower kneading drums 11 and 13, a driving motor 27 rotating the lower kneading drum 11, and a belt 25 linking the rotation shafts 23 of the upper and lower kneading drums 11 and 13 and allowing the upper and lower kneading drums 11 and 13 to be rotated together. The rear part of the oven compartment 10 includes a barcode scanner 21.

The barcode scanner 21 reads a barcode attached on the mixing bag 7 when the mixing bag 7 is wound on the upper and lower kneading drums 11 and 13.

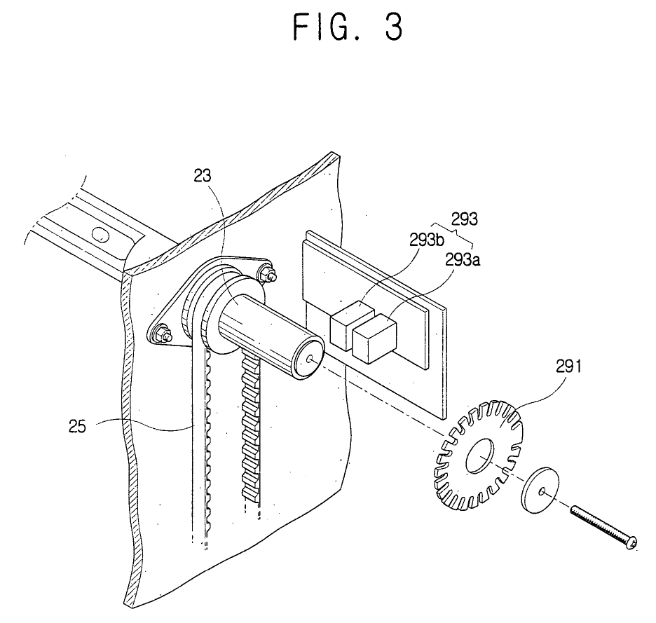

As shown in FIG. 3, the rotation sensing part 29 comprises a rotation disc 291 mounted in the rotation shaft 23 of the upper kneading drums 11 as a circular shaped member and having convex sections and concave sections in the circumference of the circular shaped member, and a rotation signal sensor 293 having a radiating part 293a and a signal sensing part 293b provided in parallel with the rotation disc 291 interposed therebetween.

Minute rotation positions of the upper kneading drum 11 are detected by using a signal generated in the radiating part 293a. The signal is transmitted toward the signal sensing part 293b and is blocked by the convex sections and transmitted through the concave sections of the rotation disc 291 in a predetermined period. Thus, a rotation position that is achieved when the upper kneading drum 11 is rotated one time is determined by sensing that a blocked time of the transmitted signal which is longer due to the movement of a predetermined section 291a of the convex sections, which is longer than the other convex sections, occurs twice, thereby indicating that the predetermined section 291(a) has made one full rotation.

The rotation positions of the upper kneading drum 11 are not sensed only by the above configuration. The rotation disc 291 may be engaged to the rotation shaft of the lower kneading drum 13. The radiating part 293a and the signal sensing part 293b of the rotation signal sensor 293 are provided, the circumference of the rotation disc 291 being interposed between the radiating part 293a and the signal sensing part 293b. Also, the rotation disc 291 may be separately provided as (i) a rotation disc to sense only minute positions and (ii) a rotation disc to sense only a rotation position when the upper or lower kneading drum 11 or 13 is rotated one time. The radiating part 293a and the signal sensing part 293b of the rotation signal sensor 293 may be provided, the rotation discs of (i) and (ii) each being respectively interposed between radiating parts similar to the radiating part 293a and signal sensing parts similar to the signal sensing part 293b of the rotation signal sensor 293.

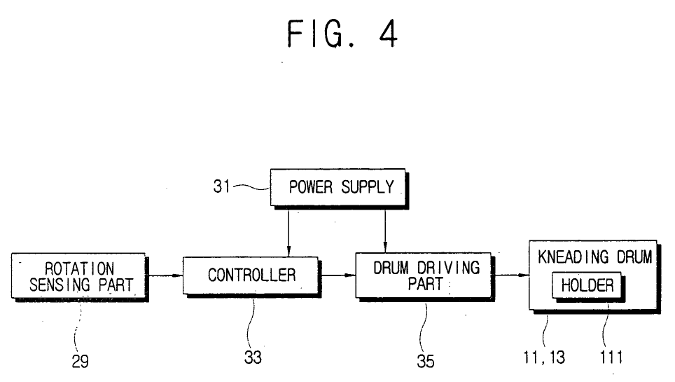

According to the present invention, a control process of the bread maker with the above configuration is described as follows, with reference to FIG. 4.

An initial power is supplied to the bread maker by a power supply 31, and then an electric signal is transmitted to a controller 33. The drum driving part 35 receives the signal from the controller 33 and rotates the upper and lower kneading drums 11 and 13 by a predetermined angle.

The rotation sensing part 29 detects rotation positions of the upper and lower kneading drums 11 and 13 and transmits signals corresponding to the detected rotation position to the controller 33. The controller 33 controls the drum driving part 35 so that the holders 111 of the upper and lower kneading drums 11 and 13 can stop within a predetermined angle range in which the holders 111 thereof face frontward.

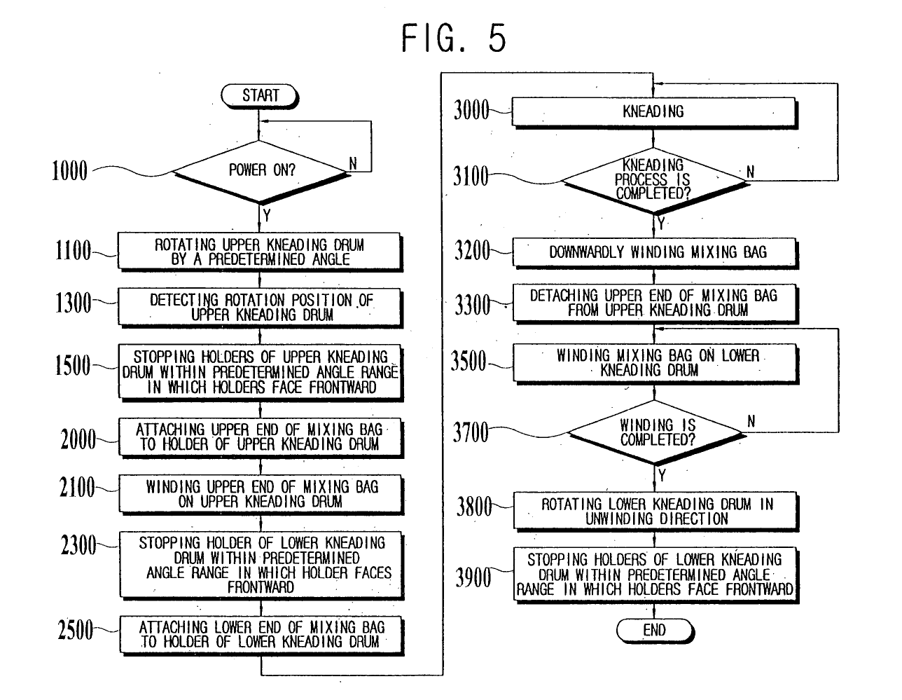

A control flow of the bread maker is described as follows with reference to FIG. 5.

If an initial power is supplied to the bread maker by the power supply 31 (1000), an electric signal is transmitted to the controller 33 and then the drum driving part 35 rotates the upper and lower kneading drums 11 and 13 by a predetermined angle (1100). Herein, the rotation sensing part 29 detects rotation positions of the upper kneading drum 11 and detects the position of the holders 111 of the upper kneading drum 11 (1300). The controller 33 receives signals corresponding to the detected rotation position of the holders 111 and controls the drum driving part 35 so that the holders 111 of the upper and lower kneading drums 11 and 13 can stop within a predetermined angle range in which the holders 111 thereof face frontward (1500).

Herein, the supplying of the initial power may be to initially supply power when power of the bread maker is off, but may include other embodiments. In a state that the power of the bread maker is on, a first electric signal to make bread may be transmitted to the controller 33 by an action of opening the door 3 of the bread maker. Also, the first electric signal to make bread may be transmitted to the controller 33 by pressing a bread making start button to start making bread.

A user attaches an upper end of the mixing bag 7 to the holder 111 of the upper kneading drum 11 (2000). That is, a user inserts holding holes 8 provided in the upper end of the mixing bag 7 into the holding projections 113 of the holder 111 of the upper kneading drums 11 formed along the axis direction of the upper kneading drum 11. The controller 33 controls the drum driving part 35 so that the upper end of the mixing bag 7 is upwardly wound on the upper kneading drum 11 (2100). Herein, the upper and lower kneading drums 11 and 13 are rotated together by the belt 25. The controller 33 controls the drum driving part 35 so that the holder 111 of the lower kneading drum 13 can stop within a predetermined angle range in which the holder 111 of the lower kneading drum 13 faces frontward (2300).

A user inserts holding holes 8 provided in a lower part of the mixing bag 7 into the holding projections 113 of the holder 111 of the lower kneading drum 13 formed along an axis direction of the lower kneading drum 13, and attaches the lower end of the mixing bag 7 to the holder 111 of the lower kneading drum 13 (2500).

The controller 33 kneads the raw materials according to a program of the barcode 9 which is attached on the mixing bag 7 and read by the barcode scanner 21 (3000). The controller 33 determines whether the kneading is completed (3100). When the kneading according to the program is completed, the controller 33 controls the drum driving part 35 so that the mixing bag 7 is downwardly wounded (3200), and thus makes the upper end of the mixing bag 7 detached from the upper kneading drum 11 (3300). The lower end of the mixing bag 7 not detached from the lower kneading drum 13 is continuously wound on the lower kneading drum 13 (3500). When the winding is completed (3700), the controller 33 controls the lower kneading drum 13 to unwind the wound mixing bag 7 (3800). The controller 33 detects rotation positions of the lower kneading drum 13 and controls the drum driving part 35 so that the holder 111 of the lower kneading drum 13 can stop within the predetermined angle range in which the holder 111 thereof faces frontward (3900).

Thus, a user can directly attach the mixing bag 7 to the upper and lower kneading drums 11 and 13 without adjusting the rotation angle of the holders 111 of the upper and lower kneading drums 11 and 13 to face frontward. In particular, even when new bread making process starts after a series of bread making processes ends, a user can directly attach the mixing bag 7 to the upper and lower kneading drums 11 and 13 without adjusting the rotation angle of the holders 111 of the upper and lower kneading drums 11 and 13 to face frontward.

As described above, according to the present invention, provided is a bread maker and a control method thereof, wherein in a predetermined process, holders provided in kneading drums of the bread maker and holding opposite ends of a mixing bag filled with raw materials for bread stop within a predetermined angle range in which the holders thereof face frontward.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A bread maker, comprising:
a main body forming an oven compartment;
upper and lower kneading drums spaced apart from each other inside the oven compartment, each kneading drum having a holder holding opposite ends of a mixing bag filled with raw materials;
a drum driving part rotating the upper and lower kneading drums;
a rotation sensing part sensing rotation positions of the holder of the upper kneading drums; and
a controller which controls the drum driving part so that when an initial power is supplied, the upper kneading drum is rotated by a predetermined angle to make the holder of the upper kneading drum stop within a predetermined angle range in which the holder of the upper kneading drum faces frontward based upon a position sensing signal of the rotation sensing part.

2. The bread maker according to claim 1, wherein the controller controls the drum driving part so that an upper end of the mixing bag is wound on the upper kneading drum by a predetermined length after being attached to the holder of the upper kneading drum, and then the holder of the lower kneading drum stops within a predetermined angle range in which the holder of the lower kneading drum faces frontward.

3. The bread maker according to claim 1, wherein the controller controls the drum driving part so that after a kneading process is completed, the mixing bag is downwardly wound to be detached from the upper kneading drum and wound on the lower kneading drum, and then the lower kneading drum is rotated to unwind the mixing bag until the holder of the lower kneading drum stops within a predetermined angle range in which the holder of the lower kneading drum faces frontward.

4. The bread maker according to claim 2, wherein the controller controls the drum driving part so that after a kneading process is completed, the mixing bag is downwardly wound to be detached from the upper kneading drum and wound on the lower kneading drum, and then the lower kneading drum is rotated to unwind the mixing bag until the holder of the lower kneading drum stops within a predetermined angle range in which the holder of the lower kneading drum faces frontward.

5. The bread maker according to claim 1, wherein the holder comprises a plurality of holding projections and the mixing bag has holding holes engaged to the holding projections.

6. A method of controlling a bread maker having a main body forming an oven compartment, upper and lower kneading drums spaced apart from each other inside the oven compartment with each kneading drum having a holder holding opposite ends of a mixing bag filled with raw materials, and a drum driving part rotating the kneading drums to knead the raw materials contained in the mixing bag, the method comprising:
supplying an initial power;
rotating the upper kneading drum by a predetermined angle;
sensing positions of the holder of the upper kneading drum; and
making the holder of the upper kneading drum stop within a predetermined angle range in which the holder of the upper kneading drum faces frontward.

7. The method according to claim 6, further comprising:
attaching an upper end of the mixing bag to the upper kneading drum and winding the upper end of the mixing bag onto the upper kneading drum by a predetermined length; and
attaching a lower end of the mixing bag to the holder of the lower kneading drum.

8. The method according to claim 7, further comprising:
kneading the raw materials in the mixing bag by rotating the upper and lower kneading drums clockwise and counterclockwise;
downwardly winding the mixing bag after the kneading process is completed;
detaching the upper end of the mixing bag from the upper kneading drum;
winding the mixing bag on the lower kneading drum;
rotating the lower kneading drum so that the wound mixing bag is unwound from the lower kneading drum; and
making the holder of the lower kneading drum stop within a predetermined angle range in which the holder of the lower kneading drum faces frontward.

9. A bread maker to make bread, comprising:
an oven compartment in which a bread making process is performed, including upper and lower kneading drums, having holders which hold the bread, to rotate and thereby knead the bread;
a drum driving part to transmit a rotational force to the upper and lower kneading drums;
a rotation sensing part, sensing a rotation position of the holder of the upper kneading drum, to generate a position sensing signal; and
a controller to control the drum driving part to rotate the upper kneading drum and make the holder of the upper kneading drum stop within a predetermined angle range based upon the position sensing signal of the rotation sensing part.

10. The bread maker according to claim 9, wherein the holders of the upper and lower kneading drums are provided along axes thereof and hold opposite ends of a mixing bag containing the raw materials.

11. The bread maker according to claim 10, wherein a side of the oven compartment comprises:
a rotation shaft of the upper kneading drum to transmit rotational force to the upper kneading drum;
a driving motor rotating the lower kneading drum; and
a belt linking the rotation shaft of the upper kneading drum to rotate together with the lower kneading drum.

12. A method of controlling a bread maker having an oven compartment in which a holder holds a mixing bag filled with raw materials to make bread, comprising:
supplying an initial power to a controller to begin a bread making process and to operate the holder;
rotating the holder by a predetermined angle;
sensing a position of the holder; and
stopping the holder within a predetermined angle range.

13. The method according to claim 12, further comprising opening a door of the bread maker to induce the supplying of the initial power to the controller.

14. The method according to claim 12, further comprising pressing a bread making start button to induce the supplying of the initial power to the controller.

15. The method according to claim 12, further comprising attaching the mixing bag to the holder before supplying an initial power to the controller.

16. A method of attaching and removing a mixing bag containing ingredients to make bread to and from holders on upper and lower kneading drums of a bread maker to carry out a bread making process, comprising:
supplying an initial power to a controller to begin the bread making process;
attaching the mixing bag to the upper and lower kneading drum holders;
performing the bread making process by winding the mixing bag on the upper and lower kneading drums, thereby kneading the ingredients;
unwinding the mixing bag from the upper kneading drum when the bread making process is complete by winding the mixing bag on the lower kneading drum; and
positioning the lower kneading drum so that the lower kneading drum holders face forward, when the winding the mixing bag is unwound from the upper kneading drum.

17. The method according to claim 16, wherein the attaching the mixing bag to the upper and lower kneading drums comprise:
attaching the mixing bag to the upper kneading drum; and
attaching the mixing bag to the lower kneading drum after the mixing bag has been attached to the upper kneading drum.

18. The method according to claim 17, wherein the attaching the mixing bag to the upper kneading drum comprises:
rotating the upper kneading drum by a predetermined angle;
detecting a rotation position of the upper kneading drum; and
stopping the rotation of the upper kneading drum so the upper kneading drum holder faces forward relative to the bread maker.

19. The method according to claim 18, wherein the attaching the mixing bag to the lower kneading drum comprises rotating the upper and lower kneading drums to wind an upper end of the mixing bag on the upper kneading drum and stopping in a particular rotation position such that the lower kneading drum holder faces forward relative to the bread maker.

20. The method according to claim 16, wherein the attaching the mixing bag to the upper and lower kneading drums comprises:
attaching the mixing bag to the lower kneading drum; and
attaching the mixing bag to the upper kneading drum after the mixing bag is attached to the lower kneading drum.
